(19) United States
(12) Patent Application Publication
(10) Pub. No.: US 2024/0377578 A1
(43) Pub. Date: Nov. 14, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: TAHA MORIYAMA, TOKYO (JP); RYO YOKOYAMA, TOKYO (JP)

(21) Appl. No.: 18/555,005

(22) PCT Filed: Feb. 22, 2022
(86) PCT No.: PCT/JP2022/007332

§ 371 Date: Oct. 12, 2023

(30) Foreign Application Priority Data
Apr. 26, 2021 (JP) 2021-074248

(51) Int. Cl. G02B 6/06; H04N 9/31

(52) U.S. Cl. CPC G02B 6/06; H04N 9/31

(57) ABSTRACT

An information processing device includes: a display control unit configured to perform display control of a display unit that outputs a video to be projected on a projection surface formed by proximal ends of a plurality of light guide bodies that propagates light input from the proximal ends to distal ends; and a movement control unit configured to perform control of a movement drive unit that moves the distal ends of the plurality of light guide bodies forming a drawing surface.

### TECHNICAL FIELD

The present technology relates to an information processing device, an information processing method, and a program, and particularly relates to a technology for providing a tactile stimulus.

### BACKGROUND ART

There has been proposed a device that conducts a video from a projector from proximal end sides of a large number of optical fibers and displays the video as an image from distal ends of these optical fibers.

### CITATION LIST

### Patent Document

Patent Document 1: Japanese Patent Application Laid-Open No. 2002 049337

### SUMMARY OF THE INVENTION

### Problems to be Solved by the Invention

On the other hand, in recent years, a technology for providing a tactile stimulus to a user has been developed. Here, the tactile stimulus refers to a physical phenomenon that causes the user to feel a tactile sensation by a vibration phenomenon or the like. In addition, generating a tactile stimulus is referred to as tactile presentation.

A technology for performing tactile presentation is used in devices in various fields.

For example, in a terminal device including a touch panel such as a smartphone, the touch panel or a housing vibrates in response to a touch operation from a user and gives a tactile stimulus to a user's finger, so that a touch feeling on a button or the like displayed on the touch panel can be expressed.

However, in the terminal device described above, only one vibrator that gives a tactile stimulus is provided, and a fine tactile stimulus according to the video cannot be given to the user.

Therefore, an object of the present technology is to provide a tactile stimulus according to a video.

### Solutions to Problems

An information processing device according to the present technology includes: a display control unit configured to perform display control of a display unit that outputs a video to be projected on a projection surface formed by proximal ends of a plurality of light guide bodies that propagates light input from the proximal ends to distal ends; and a movement control unit configured to perform control of a movement drive unit that moves the distal ends of the plurality of light guide bodies forming a drawing surface.

As a result, the information processing device can change a surface shape of the drawing surface by causing the video to be displayed on the drawing surface through the light guide bodies and moving the distal ends of the plurality of light guide bodies forming the drawing surface.

### BRIEF DESCRIPTION OF DRAWINGS

FIG. 1 is a schematic configuration diagram of a tactile and haptic presentation device.

FIG. 2 is a schematic perspective view of the tactile and haptic presentation device.

FIG. 3 is a view illustrating a structure of a drawing surface support unit.

FIG. 4 is a diagram illustrating a structure of a movement drive unit.

FIG. 5 is a block diagram of the tactile and haptic presentation device.

FIG. 6 is a diagram illustrating an example of tactile presentation processing.

FIG. 7 is a diagram for explaining another example of the tactile presentation processing.

FIG. 8 is a diagram for explaining haptic presentation processing.

FIG. 9 is a flowchart illustrating a flow of tactile and haptic presentation processing.

FIG. 10 is a flowchart illustrating a flow of tactile and haptic presentation processing according to a modification.

FIG. 11 is a diagram illustrating a display unit according to the modification.

### MODE FOR CARRYING OUT THE INVENTION

Hereinafter, embodiments will be described in the following order.
<1. External configuration of tactile and haptic presentation device>
<2. Block configuration of tactile and haptic presentation device>
<3. Tactile presentation processing>
<4. Haptic presentation processing>
<5. Flow of tactile and haptic presentation processing>
<6. Modification>
<7. Summary>
<8. Present technology>

Note that the terms used in the present disclosure are defined as follows.

Tactile stimulus: A physical phenomenon for causing a person to perceive cutaneous sensations that are mainly felt on a skin of the person.

Tactile presentation: To generate of a tactile stimulus.

Haptic stimulus: A physical phenomenon for causing a person to perceive a sense of reaction force upon contact with a body.

Haptic presentation: To generate a haptic stimulus.

### 1. External Configuration of Tactile and Haptic Presentation Device

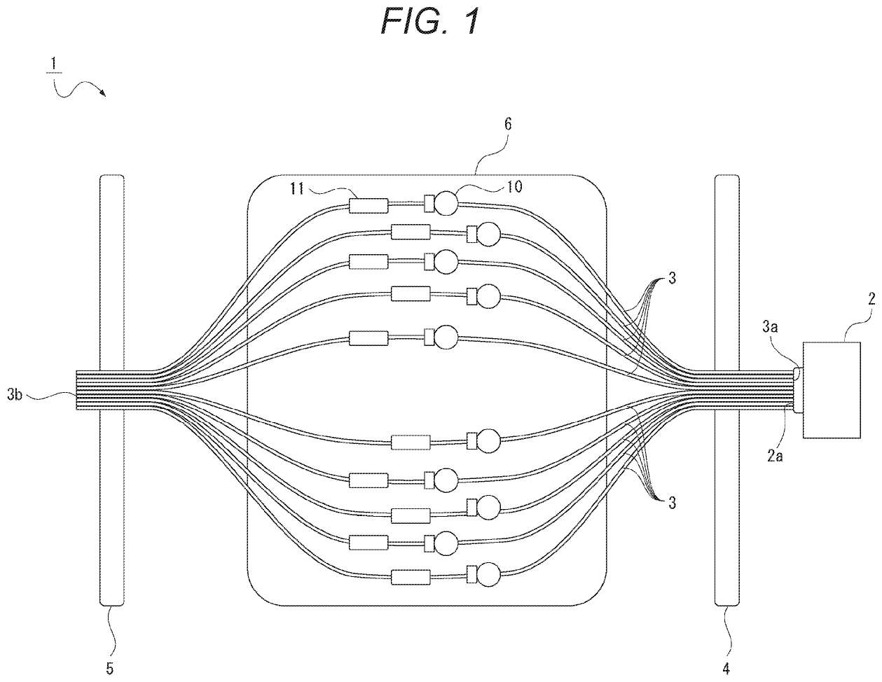

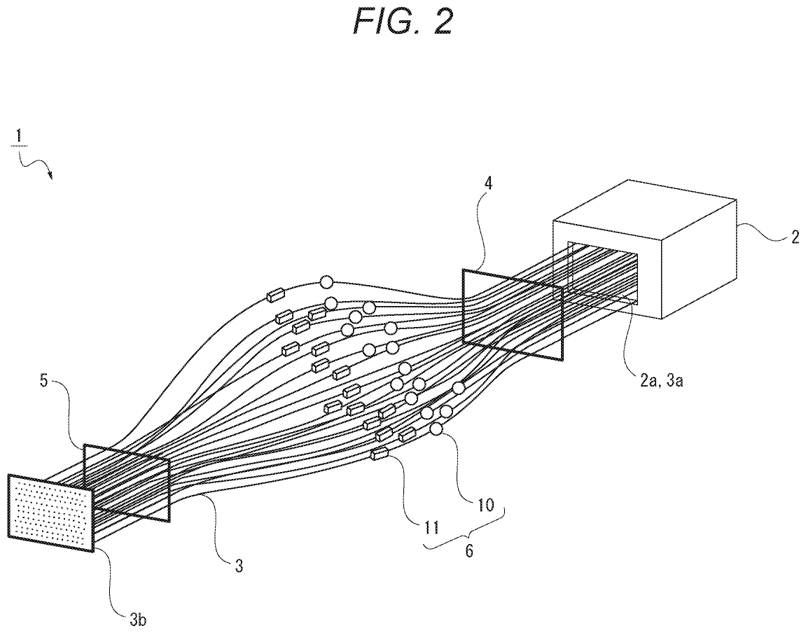

FIG. 1 is a schematic configuration diagram of a tactile and haptic presentation device 1. FIG. 2 is a schematic perspective view of the tactile and haptic presentation device 1. As illustrated in FIGS. 1 and 2, the tactile and haptic presentation device 1 as an information processing device according to the present technology includes a display unit 2, optical fibers 3, a projection surface support unit 4, a drawing surface support unit 5, and a drive unit 6.

The display unit 2 has a display panel 2a such as a liquid crystal display or an organic electro-luminescence (EL) display, for instance. In the display panel 2a, a plurality of pixels is arranged in a row direction and a column direction. The display unit 2 displays a video (still image, moving image) based on video data on the display panel 2a.

The optical fibers 3 correspond to light guide bodies of the present technology, and are formed in a thin wire shape (fibrous shape) by quartz glass or plastic. The optical fibers 3 have flexibility, and propagate light incident from proximal ends (one end) to distal ends (the other end) while totally reflecting the light. The number of optical fibers 3 is, for example, the same as the number of pixels of the display panel 2a.

The proximal ends of the optical fibers 3 are aligned in accordance with the pixel arrangement of the display panel 2a, and form a flush projection surface 3a. Then, the projection surface 3a abuts against the display panel 2a of the display unit 2. At this time, the proximal ends of the optical fibers 3 abut against the respective pixels of the display panel 2a.

As a result, light (video light) of each of pixels emitted from the display panel 2a is input to a proximal end of each of the optical fibers 3. That is, it can be asserted that the display unit 2 projects the video on the projection surface 3a.

Then, in the optical fibers 3, the video light emitted from each of the pixels of the display panel 2a is captured therein from the proximal end, and this video light is propagated to the distal end.

The optical fibers 3 are supported and fixed to the projection surface support unit 4 at a predetermined position on the proximal end side. The optical fibers 3 are maintained in a state of being abutted against each of the pixels of the display panel 2a by the projection surface support unit 4.

Also, the optical fibers 3 are supported by the drawing surface support unit 5 so as to be linearly movable at a predetermined position on the distal end sides.

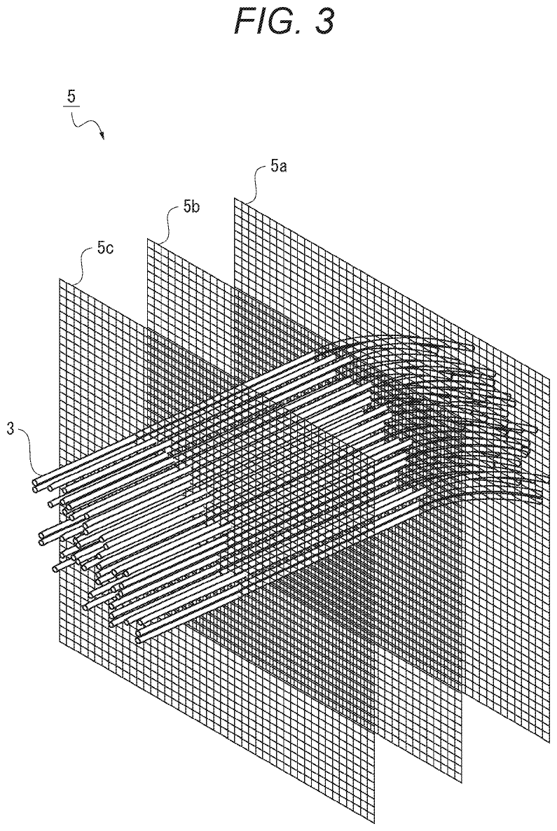

FIG. 3 is a diagram illustrating a structure of the drawing surface support unit 5. Note that in FIG. 3, only a part of the optical fibers 3 is illustrated.

As illustrated in FIG. 3, the drawing surface support unit 5 includes three pieces of mesh units 5a to 5c. In the mesh units 5a to 5c, a large number of through holes are formed by connecting metal thin wires in a lattice shape. Furthermore, the mesh units 5a to 5c are disposed at predetermined intervals in a direction (hereinafter, referred to as an orthogonal direction) orthogonal to a plane direction.

The mesh units 5a to 5c are disposed such that a large number of through holes having a size into which the optical fibers 3 can be inserted are arranged in a vertical direction and a horizontal direction. Furthermore, the mesh units 5a to 5c are disposed such that the through-holes formed in the mesh units 5a to 5c are aligned in the orthogonal direction.

Therefore, the optical fibers 3 are inserted into the through holes of the mesh units 5a to 5c so as to correspond to the arrangement of the pixels of the display panel 2a, so that the distal end side of the drawing surface support unit 5 is along the orthogonal direction.

Note that the projection surface support unit 4 may have the same structure as that of the drawing surface support unit 5.

Also, as illustrated in FIGS. 1 and 2, in the optical fibers 3, the distal ends protruding from the drawing surface support unit 5 are arranged in the row direction and the column direction similarly to the pixel arrangement of the display panel 2a, thereby forming the drawing surface 3b. As a result, the video displayed on the display panel 2a is displayed (output) on the drawing surface 3b which is configured by the distal ends of the plurality of optical fibers 3.

Furthermore, the optical fibers 3 are disposed so as to be bent between the projection surface support unit 4 and the drawing surface support unit 5.

The drive unit 6 includes a movement drive unit 10 and a vibration drive unit 11. The movement drive unit 10 and the vibration drive unit 11 are disposed in a space which is formed between the projection surface support unit 4 and the drawing surface support unit 5 so that the plurality of optical fibers 3 is disposed to be bent. Note that the movement drive unit 10 and the vibration drive unit 11 are supported by a rack (not illustrated) or the like.

The movement drive unit 10 is provided for each one or the plurality of optical fibers 3 and moves (linearly moves) the optical fiber 3. At this time, since the proximal end side of the optical fibers 3 is fixed to the projection surface support unit 4, the distal end side moves when the optical fibers 3 are moved by the movement drive unit 10. That is, the movement drive unit 10 moves the distal ends of the optical fibers 3 in the drawing surface 3b in the direction orthogonal to the drawing surface 3b (the direction in which the optical fibers 3 extend).

For example, in a case where the movement drive unit 10 is provided for each one of the optical fibers 3, the movement drive unit moves one optical fiber 3. In addition, in a case where the movement drive unit 10 is provided for each one of the plurality of optical fibers 3, the plurality of optical fibers 3 is moved together.

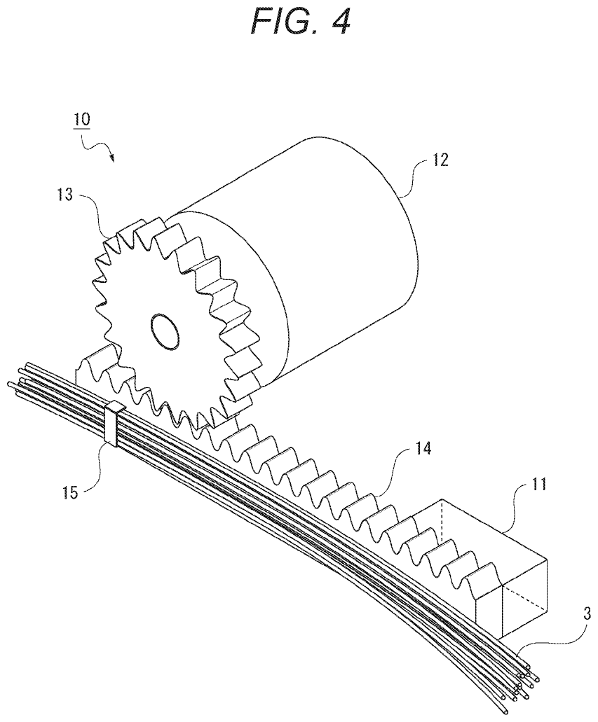

FIG. 4 is a diagram illustrating a structure of the movement drive unit 10. Note that FIG. 4 illustrates a case where the movement drive unit 10 is provided for each of the plurality of optical fibers 3.

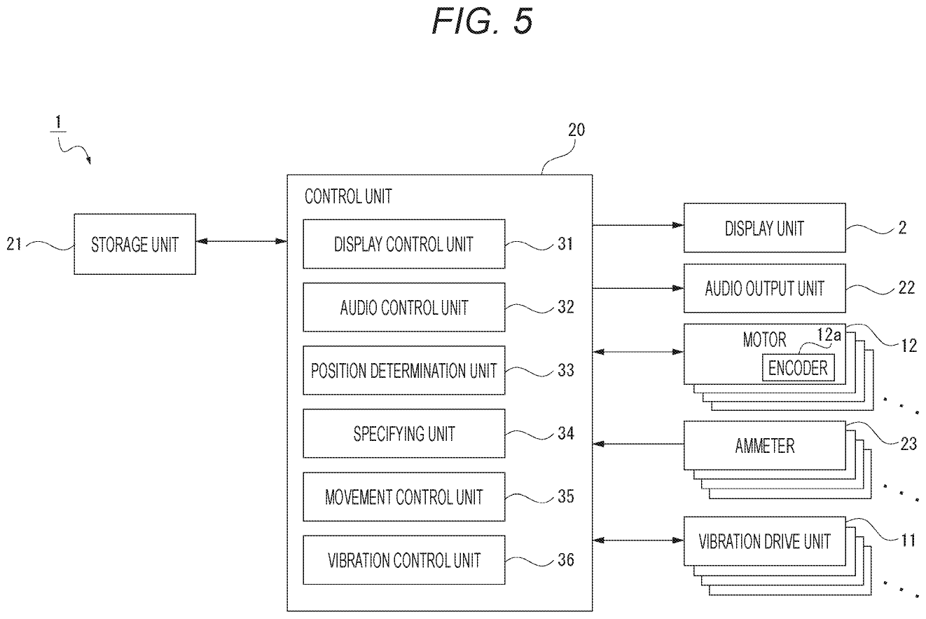

As illustrated in FIG. 4, the movement drive unit 10 includes a motor 12, a pinion 13, a rack 14, and a binding member 15. The motor 12 is, for example, a servomotor, and is rotationally driven on the basis of the control of the control unit 20 (see FIG. 5).

The pinion 13 is a cylindrical gear and is fixed to a motor shaft of the motor 12. The rack 14 is a plate-like or rod-like gear, and is meshed with the pinion 13. The binding member 15 binds one or more pieces of the optical fibers 3 to the rack 14.

Therefore, in the movement drive unit 10, when the motor 12 is driven on the basis of the control of the control unit 20 and the motor shaft is rotated, the pinion 13 rotates together with the motor shaft. Then, the rack 14 meshed with the pinion 13 linearly moves, thereby linearly moving the optical fibers 3 together with the rack 14.

Furthermore, the vibration drive unit 11 is fixed to the rack 14. The vibration drive unit 11 is configured by a vibration actuator (vibrator), is driven on the basis of the control of the control unit 20, and applies vibration to the optical fibers 3 via the rack 14. Note that the vibration drive unit 11 only needs to apply vibration to the optical fibers 3, and may not be fixed to the rack 14. In addition, the vibration drive unit 11 is provided for each one or a plurality of optical fibers 3, and applies vibration to each one or a plurality of optical fibers 3.

### 2. Block Configuration of Tactile and Haptic Presentation Device

FIG. 5 is a block diagram of a tactile and haptic presentation device 1. As illustrated in FIG. 5, the tactile and haptic presentation device 1 includes a control unit 20, a storage unit 21, an audio output unit 22, and ammeters 23 in addition to the above-described configuration.

The control unit 20 includes a microcomputer including, for example, a central processing unit (CPU), a read-only memory (ROM), a random access memory (RAM), and the like, and performs overall control of the tactile and haptic presentation device 1 by executing processing according to a program stored in the ROM.

The storage unit 21 comprehensively represents a storage device such as a hard disk drive (HDD) or a solid-state drive (SSD), for example, and is used for storing various data in the tactile and haptic presentation device 1.

For example, the storage unit 21 stores content data including video data (video data) displayed on the display unit 2 and audio data (audio data) output from the audio output unit 22.

Note that the content data may include information (depth information, texture information, and hard/soft information) for performing tactile presentation and haptic presentation from the optical fiber 3 by driving the drive unit 6.

Here, the depth information is information indicating a distance, a position, or a height in a depth direction (a direction orthogonal to a video plane) of an object displayed as a video.

Also, the texture information is information for expressing texture of an object. Specifically, the texture information indicates a frequency for vibrating the vibration drive unit 11 to express the texture of the object.

Furthermore, the hard/soft information is information for expressing the hardness of the object, and indicates, for example, a numerical value according to the hardness or softness.

Note that the object is not limited to a body, and may be a background or the like.

The audio output unit 22 is a speaker, a headphone, or the like, and outputs audio based on audio data.

The ammeter 23 is provided for each of the motors 12, measures a current value of the motor 12, and outputs the measurement result (detection result) to the control unit 20.

The motor 12 is provided with each of encoders 12a, detects a position, a speed, and the like at the time of driving the motor 12, and outputs the detection result to the control unit 20.

The control unit 20 functions as a display control unit 31, an audio control unit 32, a position determination unit 33, a specifying unit 34, a movement control unit 35, and a vibration control unit 36 in a case where the control unit performs tactile and haptic presentation processing to be described later.

The display control unit 31 reads video data included in the content data stored in the storage unit 21, and causes the display unit 2 to display a video based on the video data.

The audio control unit 32 reads audio data included in the content data stored in the storage unit 21, and causes the audio output unit 22 to output an audio based on the audio data.

The position determination unit 33 determines positions of distal ends of the optical fibers 3 (the positions in the direction orthogonal to the drawing surface 3b), respectively, on the basis of the depth information included in the content data stored in the storage unit 21, the video displayed on the display unit 2, and the like.

In a case where a distal end of an optical fiber 3 is moved by being pushed by a user or the like, that is, in a case where an external force is input to the distal end of the optical fiber 3, the specifying unit 34 specifies the optical fiber 3 to which the external force is input.

The movement control unit 35 drives and controls the motor 12 on the basis of the position determined by the position determination unit 33 to perform the movement control of the distal ends of the optical fibers 3. Also, the movement control unit 35 drives and controls the motor 12 corresponding to the optical fiber 3 specified by the specifying unit 34. For example, when driving and controlling the motor 12, the movement control unit 35 performs position control based on the detection result of the encoder 12a and current control (torque control) based on the measurement result of the ammeter 23.

The vibration control unit 36 drives and controls the vibration drive unit 11 on the basis of texture information included in the content data stored in the storage unit 21.

### 3. Tactile Presentation Processing

Next, tactile presentation processing in tactile and haptic presentation processing by the control unit 20 will be described with a specific example. Note that the tactile and haptic presentation processing includes the tactile presentation processing described here and the haptic presentation processing to be described later, and these controls are simultaneously performed in parallel.

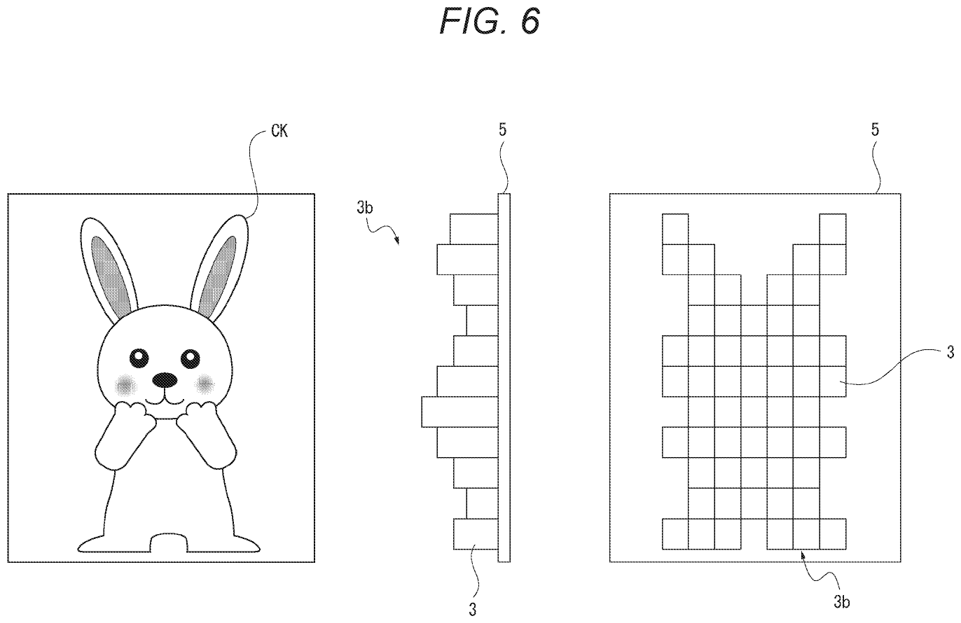

FIG. 6 is a diagram illustrating an example of tactile presentation processing. A left side of FIG. 6 illustrates a video (image) displayed on the display unit 2 and the drawing surface 3b, a center of FIG. 6 illustrates a side view of the drawing surface 3b, and a right side of FIG. 6 illustrates a front view of the drawing surface 3b.

In the storage unit 21, for example, video data, audio data, and depth information of a character CK as illustrated in FIG. 6 are stored as content data in association with each other. The depth information is calculated on the basis of, for example, three-dimensional (3D) data of the character CK.

When reading the video data from the storage unit 21, the display control unit 31 causes the display unit 2 to display a video (character CK) based on the video data as illustrated on the left side of FIG. 6, for example. As a result, the display control unit 31 displays the character CK on the drawing surface 3b formed by the distal ends of the optical fibers 3.

When reading audio data from the storage unit 21, the audio control unit 32 causes the audio output unit 22 to output an audio based on the audio data.

The position determination unit 33 reads depth information corresponding to the video data of the character CK from the storage unit 21. Then, the position determination unit 33 determines a position of a distal end of the optical fiber 3 for each of the optical fibers 3 on which the character CK is displayed as illustrated on the right side of FIG. 6 on the basis of the read depth information.

For example, the position determination unit 33 determines a position of a distal end of each of the optical fibers 3 on the basis of the depth information such that the distal end of the optical fiber 3 on which the character CK is displayed comes forward with the position of the distal end of the optical fiber 3 on which a background other than the character CK is displayed as a reference position.

In addition, the position determination unit 33 calculates a movement amount (rotation angle) for moving a distal end of the optical fibers 3 from a current position to a determined position for each of the motors 12. Note that the current position is calculated from the detection result of the encoder 12a of the motor 12.

The movement control unit 35 performs drive control on each of the motors 12 by specifying the movement amount calculated by the position determination unit 33 as a command value. Note that the movement control unit 35 designates not only the above-described movement amount but also the current value (torque) as the command value when controlling the drive of the motor 12.

As a result, the distal ends of the optical fibers 3 are moved to positions corresponding to an uneven shape of the character CK as illustrated in the center of FIG. 6. Therefore, the drawing surface 3b has a surface shape along the uneven shape of the character CK.

Then, in the tactile and haptic presentation device 1, the drawing surface 3b is touched by the user, so that a stereoscopic effect of the character CK can be presented to the user as a tactile stimulus.

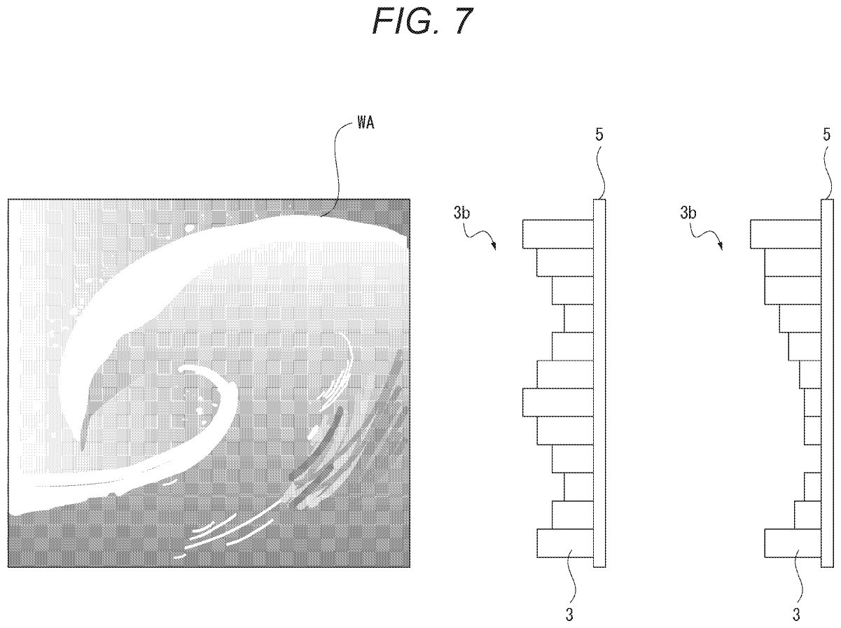

FIG. 7 is a diagram illustrating another example of the tactile presentation processing. A left side of FIG. 7 illustrates a video displayed on the display unit 2, a center of FIG. 7 illustrates a side view of the drawing surface 3b at a predetermined time t1, and a right side of FIG. 7 illustrates a side view of the drawing surface 3b at a time t2 after the time t1.

The storage unit 21 stores, for example, video data, audio data, depth information, and texture information in which a wave WA is deformed with time. Note that the depth information here indicates the position in the depth direction of the wave WA at predetermined time intervals, for example, in units of pixels.

When reading the video data from the storage unit 21, the display control unit 31 causes the display unit 2 to display a video (wave WA) based on the video data as illustrated on the left side of FIG. 7, for example. As a result, the display control unit 31 displays the video of the wave WA on the drawing surface 3b formed by the distal ends of the optical fibers 3.

When reading audio data from the storage unit 21, the audio control unit 32 causes the audio output unit 22 to output an audio based on the audio data.

The position determination unit 33 reads depth information corresponding to the video data of the wave WA from the storage unit 21. Then, the position determination unit 33 determines the positions of the distal ends of the optical fibers 3 corresponding to the wave WA that deforms in accordance with the video on the basis of the read depth information. Therefore, here, the positions of the distal ends of the optical fibers 3 on which the wave WA is displayed are determined to be the positions illustrated in the center of FIG. 7 at time t1, and are determined to be the positions illustrated on the right side of FIG. 7 at time t2.

In addition, the position determination unit 33 calculates a movement amount (rotation angle) for moving a distal end of each of the optical fibers 3 from the current position to the determined position for each of the motors 12.

The movement control unit 35 performs drive control on each of the motors 12 by specifying the movement amount calculated by the position determination unit 33 as a command value while changing the command value over time.

As a result, as illustrated in the center of FIG. 7 and the right side of FIG. 7, the distal ends of the optical fibers 3 are moved to the positions corresponding to the shape of the wave WA that changes with time. Therefore, the drawing surface 3b has a surface shape along the uneven shape of the wave WA that changes with time.

Then, in the tactile and haptic presentation device 1, the drawing surface 3b is touched by the user, so that a stereoscopic effect of the wave WA can be presented to the user as a tactile stimulus.

In addition, if the texture information is read from the storage unit 21, the vibration control unit 36 drives the vibration drive unit 11 to vibrate the optical fibers 3 corresponding to the wave WA at the frequency indicated by the texture information on the basis of the texture information.

As a result, in the tactile and haptic presentation device 1, the drawing surface 3b is touched by the user to give a vibration stimulus, and the texture of the wave WA can be presented to the user as a tactile stimulus.

### 4. Haptic Presentation Processing

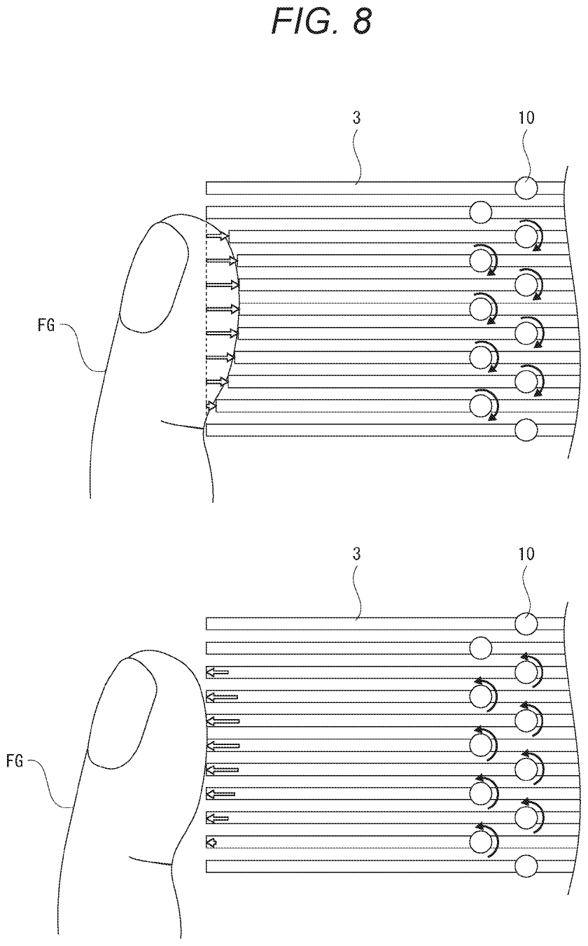

FIG. 8 is a diagram illustrating haptic presentation processing. As indicated by an outlined arrow in an upper part of FIG. 8, when the drawing surface 3b is pressed by the user, the pressed optical fibers 3 move to the back side (right side in the drawing). At this time, as indicated by a black arrow in the upper part of FIG. 8, the motors 12 that drive the moved optical fibers 3 are rotated. If the motors 12 rotate, counter electromotive forces are generated in the motors 12 due to the rotations, so that the current values also change.

Therefore, the specifying unit 34 specifies the optical fibers 3 pressed by the user on the basis of the current values detected by the ammeters 23. Specifically, the specifying unit 34 acquires a current value detected by the ammeter 23 for each of the motors 12. Then, for each of the motors 12, the specifying unit 34 determines (compares) whether the current value (command value) output to the motor 12 in the tactile presentation control described above matches the acquired current value.

Then, the specifying unit 34 determines that a counter electromotive force is not generated in the motor 12 in which the command value matches the acquired current value, that is, the corresponding optical fiber 3 is not pressed by the user. On the other hand, the specifying unit 34 determines that a counter electromotive force is generated in the motor 12 in which the command value and the acquired current value do not match, that is, the corresponding optical fiber 3 is pressed by the user.

Then, when the optical fiber 3 pressed by the user is specified, the movement control unit 35 controls the motor 12 corresponding to the optical fiber 3 to designate a command value (corrected command value) in which the current value is increased or decreased by a difference between the command value and the acquired current value.

As a result, the movement control unit 35 causes the motor 12 to generate (output) a reaction force corresponding to the force (external force) of the user pressing down the optical fiber 3. Then, the movement control unit 35 rotates the motors 12 as indicated by the black arrow in the lower part of FIG. 8, and moves the optical fibers 3 as indicated by the white arrow.

Therefore, in the tactile and haptic presentation device 1, the optical fibers 3 pressed by the user can present forces stimuli to be pushed back to the user.

### 5. Flow of Tactile and Haptic Presentation Processing

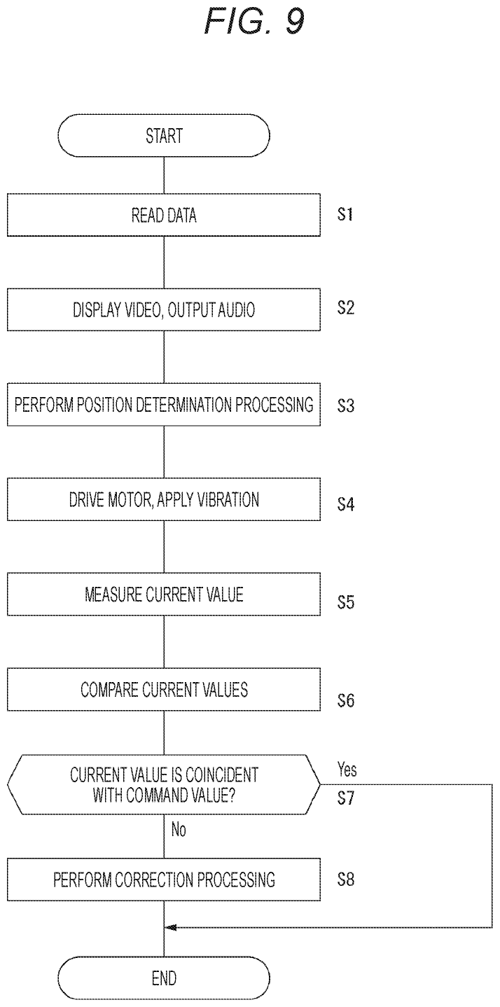

FIG. 9 is a flowchart illustrating a flow of tactile and haptic presentation processing. As illustrated in FIG. 9, when the tactile and haptic presentation processing is started, the control unit 20 reads the content data stored in the storage unit 21 in step S1. Then, in step S2, the display control unit 31 causes the display unit 2 to display a video based on the video data included in the content data. Furthermore, the audio control unit 32 causes the audio output unit 22 to output an audio based on the audio data included in the content data.

In step S3, the position determination unit 33 determines a position of a distal end of each of the optical fibers 3 on the basis of the depth information included in the content data, and calculates a movement amount of the motor 12 by which the distal end of each of the optical fibers 3 moves to the determined position. Then, in step S4, the movement control unit 35 drives the motor 12 using the calculated movement amount and a predetermined current value as command values. In addition, in a case where the texture information is included in the content data, the vibration control unit 36 drives the vibration drive unit 11 on the basis of the vibration information to vibrate the optical fiber 3.

In step S5, the specifying unit 34 acquires a current value of each of the motors 12 measured by each of the ammeters 23. Then, in step S6, the specifying unit 34 compares the acquired current value with the command value (current value) for each of the motors 12. Furthermore, in step S7, the specifying unit 34 determines whether the current value matches the command value as a comparison result in step S6.

Then, as to the motor 12 in which the current value and the command value do not match due to the depression of the optical fiber 3 by the user (No in step S7), the movement control unit 35 performs control to designate a command value in which the current value is corrected by a difference between the command value and the acquired current value in step S8.

### 6. Modification

Note that the embodiments are not limited to the specific examples described above, and may be configured as various modifications.

For example, in the above-described embodiments, the case where the content data includes the depth information has been described. However, the content data may not include the depth information.

In this case, it is preferable that the position determination unit 33 predicts a movement of an object from a video (image) displayed on the display unit 2 to generate the depth information.

For example, the position determination unit 33 may perform the image processing on the video to specify an edge of the object, and generate depth information for moving only the corresponding optical fiber 3 within the edge forward by a predetermined distance.

Furthermore, the position determination unit 33 may perform image processing on a video to specify a black portion, and generate depth information for retracting the specified black portion backward.

In addition, the position determination unit 33 may perform image processing on a video to detect a movement of an object, and generate the depth information such that the distal end of the optical fiber 3 moves according to the movement.

In addition, the position determination unit 33 may perform image processing on the video to detect the movement of the object, and may correct the depth information such that the distal end of the optical fiber 3 moves in a dynamic range according to the detected movement.

Furthermore, in the above-described embodiments, as the method of controlling the movements of the distal ends of the optical fibers 3 on the basis of the detection results of the external forces input to the distal ends of the light guide bodies, the optical fiber 3 pressed by the user is specified on the basis of the current value of the motor 12, and the current value is corrected. However, the optical fiber 3 pressed by the user may be specified on the basis of the movement amount of the motor 12, and the movement amount may be corrected.

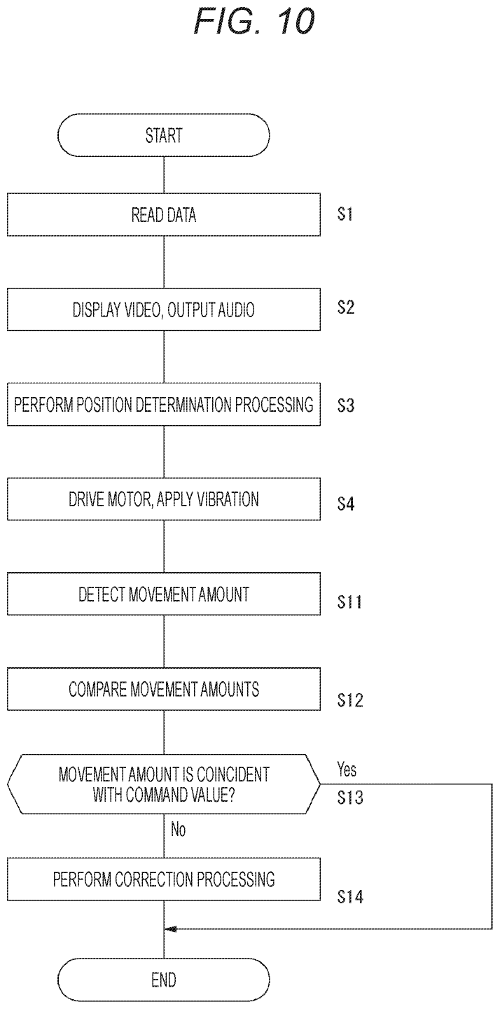

For example, as illustrated in FIG. 10, in step S11 subsequent to step S4, the movement control unit 35 calculates a movement amount of each of the motors 12 on the basis of a detection result of each of the encoders 12a. Then, In step S12, the specifying unit 34 compares the acquired movement amount with the command value (movement amount) for each of the motors 12. Furthermore, in step S13, the specifying unit 34 determines whether the movement amount matches the command value as a comparison result of step S12.

Then, as to the motor 12 whose movement amount does not match the command value due to the depression of the optical fiber 3 by the user (No in step S13), the movement control unit 35 performs control to designate a command value in which the movement amount is corrected by a difference between the command value and the acquired movement amount in step S14.

As a result, it is possible to give the user a feeling of strength (haptic stimulus) for returning the distal end of the optical fiber 3 to the original position.

Also, in the above-described embodiment, the display unit 2 is provided with the display panel 2a, and the video displayed on the display panel 2a is projected onto the optical fibers 3.

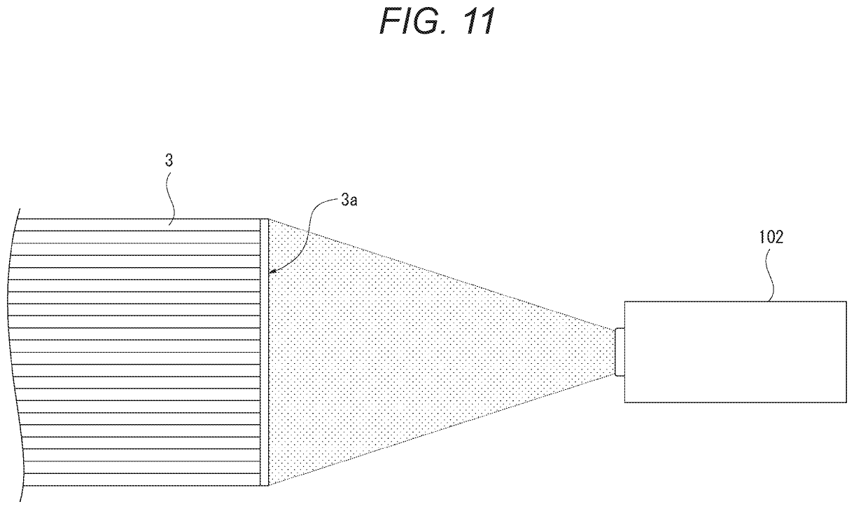

However, as illustrated in FIG. 11, a display unit 102 may be configured by a laser projector, for example, and may project a video on the projection surface 3a.

In the above-described embodiment, the optical fibers 3 are used as the light guide body, but the light guide body is not limited thereto as long as the light guide body includes a material that propagates light from the proximal ends to the distal ends. For example, the light guide body may be ulexite (television stone) or the like.

In addition, in a case where the content data includes hard/soft information, the movement control unit 35 may correct the movement amount or the current value on the basis of the hard/soft information with respect to the optical fiber 3 pressed by the user and designate the corrected movement amount or current value as the command value. For example, it is preferable that the correction amount is increased for a hard object, and the correction amount is decreased for a soft object.

As described above, by controlling the position of the distal end of the optical fiber 3 on the basis of the hard/soft information, the hardness/softness feelings of the object can be given to the user as a haptic stimulus.

### 7. Summary

According to the above embodiments, the following effects can be obtained.

An information processing device (tactile and haptic presentation device 1) according to an embodiment includes: a display control unit 31 that performs display control of a display unit that outputs a video to be projected onto a projection surface 3a formed by proximal ends of a plurality of light guide bodies (optical fibers 3) that propagates light input from the proximal ends to distal ends; and a movement control unit that performs control of a movement drive unit 10 that moves the distal ends of the plurality of light guide bodies forming a drawing surface.

As a result, the information processing device can change the surface shape of the drawing surface 3b by displaying the video on the drawing surface 3b through the light guide bodies and by moving the distal ends of the plurality of light guide bodies forming the drawing surface 3b.

Therefore, the information processing device can finely change the surface shape of the drawing surface 3b according to the video, and can finely control and provide the tactile stimulus according to the video while displaying the video.

Furthermore, in the information processing device, it is conceivable that the light guide bodies are disposed to be bent between the projection surface 3a and the drawing surface 3b, and the movement control unit drives the movement drive unit disposed between the projection surface and the drawing surface.

As a result, the information processing device can dispose the movement drive unit utilizing the space formed by disposing the light guide bodies in a bending manner between the projection surface 3a and the drawing surface 3b.

Therefore, the information processing device can effectively use the space between the projection surface 3a and the drawing surface 3b.

Furthermore, in the information processing device, the movement control unit performs the movement control of the distal ends of the light guide bodies on the basis of the detection result (current value, movement amount) of the external force input to the distal ends of the light guide bodies.

As a result, in a case where the distal ends of the light guide bodies are pressed by the user, the information processing device can move the distal ends of the light guide bodies according to the pressing amount (force, distance).

Therefore, the information processing device can provide the haptic stimulus to the user's pressing operation.

Furthermore, in the information processing device, it is conceivable that the movement control unit performs the control to generate the reaction force according to the external force input to the distal ends of the light guide bodies.

As a result, in a case where the distal ends of the light guide bodies are pressed by the user, the information processing device can apply the reaction force to the light guide bodies to push back according to the pressing amount (force).

Therefore, the information processing device can provide the haptic stimulus of the reaction force according to the pressing operation of the user.

Furthermore, in the information processing device, it is conceivable that the movement control unit performs the control so as to return the distal ends of the light guide bodies moved by the external force input to the distal ends of the light guide bodies to the original positions.

As a result, the information processing device can apply the force to the light guide bodies so as to return the distal ends to the original positions in a case where the distal ends of the light guide bodies are pressed by the user.

Therefore, the information processing device can provide the haptic stimulus according to the pressing operation of the user.

Furthermore, in the information processing device, it is conceivable that the movement control unit performs the movement control so as to move the distal ends of the light guide bodies on the basis of the hard/soft information of the object displayed on the display unit.

As a result, in a case where the distal ends of the light guide bodies are pressed by the user, the information processing device can give the user a hard and soft feeling of the object displayed on the display unit as the haptic stimulus.

Furthermore, in the information processing device, the movement drive unit includes the motor, and the information processing device includes the specifying unit that specifies a light guide body to which the external force is input on the basis of a current value of the motor based on the external force input to the distal end of the light guide body.

As a result, the information processing device can specify a light guide body pressed by the user and perform the corrected control on the movement drive unit corresponding to this light guide body.

Therefore, the information processing device can give an accurate haptic stimulus to the user's pressing operation.

Furthermore, the information processing device includes a specifying unit that specifies the light guide body to which the external force is input on the basis of an output of an encoder that detects movement of the light guide body.

As a result, the information processing device can specify a light guide body pressed by the user and perform the corrected control on the movement drive unit corresponding to this light guide body.

Therefore, the information processing device can give an accurate haptic stimulus to the user's pressing operation.

Furthermore, in the information processing device, it is conceivable that the movement control unit performs movement control of the distal ends of the light guide bodies on the basis of the depth information of the object displayed on the display unit.

As a result, the information processing device can obtain the surface shape in which the depth of the object is reproduced on the drawing surface.

Therefore, the information processing device can present the shape of the object to the user by the tactile stimulus.

Furthermore, in the information processing device, the light guide body may be an optical fiber.

As a result, by using an optical fiber having moderate flexibility, it is possible to easily move a distal end of the optical fiber and present a tactile stimulus and a haptic stimulus to the user.

In addition, the information processing method performs display control of a display unit that outputs a video to be projected on a projection surface formed by proximal ends of a plurality of light guide bodies that propagates light input from the proximal ends to the distal ends, and performs control of a movement drive unit that moves the distal ends of the plurality of light guide bodies forming the drawing surface.

Furthermore, the program causes the information processing device to execute processing of performing display control of a display unit that outputs a video to be projected on a projection surface formed by proximal ends of a plurality of light guide bodies that propagates light input from the proximal ends to the distal ends, and performing control of a movement drive unit that moves the distal ends of the plurality of light guide bodies that forms the drawing surface.

Even in such an information processing method and program, the similar effects as those of the information processing device can be obtained.

Such a program can be recorded in advance in an HDD as a recording medium built in a device such as a computer device, a ROM in a microcomputer having a CPU, or the like.

Alternatively, the program can be temporarily or permanently stored (recorded) in a removable recording medium such as a flexible disk, a compact disc read-only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program may also be installed from a removable recording medium to a personal computer or the like, or can be downloaded from a download site via a network such as a local area network (LAN) or the Internet.

Furthermore, such a program is suitable for providing the information processing device according to the embodiment in a wide range. For example, downloading the program to a mobile terminal device such as a smartphone or a tablet, a mobile phone, a personal computer, a video game console, a video device, a personal digital assistant (PDA), or the like allows such a device to function as the information processing device of the present disclosure.

Note that the effects described in the present specification are merely examples and are not limited, and other effects may be provided.

### 8. Present Technology

Note that the present technology can also employ the following configurations.

(1)

An information processing device including:
a display control unit configured to perform display control of a display unit that outputs a video to be projected on a projection surface formed by proximal ends of a plurality of light guide bodies that propagates light input from the proximal ends to distal ends; and
a movement control unit configured to perform control of a movement drive unit that moves the distal ends of the plurality of light guide bodies forming a drawing surface.
   (2)

The information processing device according to (1), in which
the light guide body is disposed to be bent between the projection surface and the drawing surface, and
the movement control unit drives the movement drive unit disposed between the projection surface and the drawing surface.
   (3)

The information processing device according to (1) or (2), in which
the movement control unit performs movement control of the distal end of the light guide body on the basis of a detection result of an external force input to the distal end of the light guide body.
   (4)

The information processing device according to (3), in which
the movement control unit performs control to generate a reaction force corresponding to the external force input to the distal end of the light guide body.
   (5)

The information processing device according to (3), in which
the movement control unit performs control so as to return the distal end of the light guide body moved by the external force input to the distal end of the light guide body to an original position.
   (6)

The information processing device according to any one of (3) to (5), in which
the movement control unit performs movement control so as to move the distal end of the light guide body on the basis of hard/soft information of an object displayed on the display unit.
   (7)

A photodetection element according to any one of (1) to (6), in which
the movement drive unit includes a motor, and
the photodetection element includes a specifying unit configured to specify the light guide body to which an external force is input on the basis of a current value of the motor based on the external force input to the distal end of the light guide body.
   (8)

A photodetection element according to any one of (1) to (6), including
a specifying unit configured to specify the light guide body to which an external force is input on the basis of an output of an encoder that detects movement of the light guide body.
   (9)

The information processing device according to any one of (1) to (8), in which
the movement control unit performs movement control so as to move the distal end of the light guide body on the basis of depth information of the object displayed on the display unit.
   (10)

The information processing device according to any one of (1) to (9), including
a vibration control unit that controls a vibration drive unit which applies vibration to the light guide body.
   (11)

The information processing device according to (1), in which
the light guide body is an optical fiber.
   (12)

An information processing method including:
performing display control of a display unit that outputs a video to be projected on a projection surface formed by proximal ends of a plurality of light guide bodies that propagates light input from the proximal ends to distal ends; and
performing control of a movement drive unit that moves the distal ends of the plurality of light guide bodies forming a drawing surface.
   (13)

A program for causing an information processing device to execute processing that:
performing display control of a display unit that outputs a video to be projected on a projection surface formed by proximal ends of a plurality of light guide bodies that propagates light input from the proximal ends to the distal ends; and
controlling a movement drive unit that moves the distal ends of the plurality of light guide bodies forming a drawing surface.

### REFERENCE SIGNS LIST

1 Tactile and haptic presentation device
2 Display unit
3 Optical fiber
10 Movement drive unit
11 Vibration drive unit
20 Control unit
31 Display control unit
32 Audio control unit
33 Position determination unit
34 Specifying unit
35 Movement control unit
36 Vibration control unit

1. An information processing device comprising:
a display control unit configured to perform display control of a display unit that outputs a video to be projected on a projection surface formed by proximal ends of a plurality of light guide bodies that propagates light input from the proximal ends to distal ends; and
a movement control unit configured to control of a movement drive unit that moves the distal ends of the plurality of the light guide bodies forming a drawing surface.

2. The information processing device according to in claim 1, wherein
the light guide body is disposed to be bent between the projection surface and the drawing surface, and
the movement control unit drives the movement drive unit disposed between the projection surface and the drawing surface.

3. The information processing device according to claim 1, wherein
the movement control unit performs movement control of the distal end of the light guide body on a basis of a detection result of an external force input to the distal end of the light guide body.

4. The information processing device according to in claim 3, wherein
the movement control unit performs control to generate a reaction force corresponding to the external force input to the distal end of the light guide body.

5. The information processing device according to claim 3, wherein
the movement control unit performs control to return the distal end of the light guide body moved by the external force input to the distal end of the light guide body to an original position.

6. The information processing device according to claim 3, wherein
the movement control unit performs movement control to move the distal end of the light guide body on a basis of hard/soft information of an object displayed on the display unit.

7. The information processing device according to claim 1, wherein
the movement drive unit includes a motor, and
the information processing device further includes a specifying unit configured to specify the light guide body to which the external force is input on a basis of a current value of the motor based on the external force input to a distal end of the light guide body.

8. The information processing device according to claim 1, further comprising
a specifying unit configured to specify the light guide body to which an external force is input on a basis of an output of an encoder that detects movement of the light guide body.

9. The information processing device according to claim 1, wherein
the movement control unit performs movement control of the distal end of the light guide body on a basis of depth information of an object displayed on the display unit.

10. The information processing device according to claim 1, further comprising
a vibration control unit configured to control a vibration drive unit that applies vibration to the light guide body.

11. The information processing device according to claim 1, wherein
the light guide body includes an optical fiber.

12. An information processing method comprising:
performing display control of a display unit that outputs a video to be projected on a projection surface formed by proximal ends of a plurality of light guide bodies that propagates light input from the proximal ends to distal ends; and
controlling a movement drive unit that moves the distal ends of the plurality of the light guide bodies forming a drawing surface.

13. A program for causing an information processing device to execute processing that comprising:
performing display control of a display unit that outputs a video to be projected on a projection surface formed by proximal ends of a plurality of light guide bodies that propagates light input from the proximal ends to distal ends; and
controlling a movement drive unit that moves the distal ends of the plurality of the light guide bodies forming a drawing surface.
